(19) United States
(12) Patent Application Publication
(10) Pub. No.: US 2025/0285005 A1
(43) Pub. Date: Sep. 11, 2025

(54) DOMAIN GENERALIZATION FOR MACHINE LEARNING MODELS

(71) Applicant: INTERNATIONAL BUSINESS MACHINES CORPORATION, Armonk, NY (US)

(72) Inventors: Shaked Perek, Givatayim (IL); Amir Egozi, Eliav (IL); Efrat Hexter, Beit Shemesh (IL); Assaf Arbelle, Lehvot Haviva (IL)

(21) Appl. No.: 18/596,414

(22) Filed: Mar. 5, 2024

(51) Int. Cl. G06N 20/00

(52) U.S. Cl. CPC G06N 20/00

(57) ABSTRACT

Training a machine learning model for domain generalized operation includes processing, using computer hardware, a first plurality of images belonging to a first domain through a first network. A second plurality of images belonging to a second domain is processed using the computer hardware through a second network. A compound error metric is generated using the computer hardware from a plurality of plurality of error metrics derived from results generated from the processing of the first network and the processing of the second network. Weights of the first network are updated using the computer hardware based on the compound error metric. Weights of the second network are updated using the computer hardware using a moving average technique that is dependent on the weights of the first network as updated.

### BACKGROUND

This disclosure relates to domain generalization for machine learning (ML) models.

ML models are usually trained and evaluated on datasets drawn from the same distribution. In other words, an ML model, such as a Deep Learning model, generally operates under the assumption that the data to be processed at runtime, or inference time, has a similar distribution as the training data used to train the ML model. This assumption holds true for a variety of different curated benchmark data sets such as the well-known ImageNet data set. In real-world scenarios, however, this assumption rarely holds true. In real-world scenarios, a shift in the data distribution between training time and inference time often causes a significant degradation in performance of the ML model.

### SUMMARY

In one or more embodiments, a method of training a machine learning model includes processing, using computer hardware, a first plurality of images belonging to a first domain through a first network. The method includes processing, using the computer hardware, a second plurality of images belonging to a second domain through a second network. The method includes generating, using the computer hardware, a compound error metric from a plurality of error metrics derived from results generated from the processing of the first network and the processing of the second network. The method includes updating, using the computer hardware, weights of the first network based on the compound error metric. The method includes updating, using the computer hardware, weights of the second network using a moving average technique that is dependent on the weights of the first network as updated.

In one or more embodiments, a system includes one or more processors configured to perform executable operations for training a machine learning model. The executable operations include processing a first plurality of images belonging to a first domain through a first network. The executable operations include processing a second plurality of images belonging to a second domain through a second network. The executable operations include generating a compound error metric from a plurality of error metrics derived from results generated from the processing of the first network and the processing of the second network. The executable operations include updating weights of the first network based on the compound error metric. The executable operations include updating weights of the second network using a moving average technique that is dependent on the weights of the first network as updated.

In one or more embodiments, a computer program product includes a computer readable storage medium having program instructions stored thereon. The program instructions are executable by one or more processors to cause the one or more processors to execute operations for training a machine learning model. The executable operations include processing a first plurality of images belonging to a first domain through a first network. The executable operations include processing a second plurality of images belonging to a second domain through a second network. The executable operations include generating a compound error metric from a plurality of error metrics derived from results generated from the processing of the first network and the processing of the second network. The executable operations include updating weights of the first network based on the compound error metric. The executable operations include updating weights of the second network using a moving average technique that is dependent on the weights of the first network as updated.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example computing environment that is suitable for training a machine learning (ML) model and executing an ML model at runtime.

FIGS. 2A and 2B, taken collectively, illustrate a domain generalization (DG) framework in accordance with one or more embodiments of the disclosed technology.

FIG. 3 illustrates certain operative features of the DG framework of FIGS. 1 and 2.

FIG. 4 is a method illustrating certain operative features of the DG framework of FIGS. 1, 2, and 3 in accordance with one or more embodiments of the disclosed technology.

FIG. 5 illustrates a DG framework trained to perform inference in accordance with one or more embodiments of the disclosed technology.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to domain generalization for machine learning (ML) models. In accordance with the inventive arrangements described within this disclosure, methods, systems, and computer program products are provided for training an ML model to learn an invariance representation of different domains having distribution shifts. In accordance with one or more embodiments described within this disclosure, the training framework provided uses the domain(s) themselves as augmentations of a model. Using the domains as or in place of augmentations, the inventive arrangements are capable of training an ML model to accurately classify objects across a plurality of different domains having different data distributions. The resulting ML model, trained as described herein, is capable of extracting semantic information to classify objects while remaining insensitive to domain specific features. In this regard, domain generalization is differentiated from domain adaptation. Domain generalization refers to generalizing an ML model to generate accurate predictions given data items across a plurality of domains that may include unseen domains whereas domain adaptation refers to adapting an ML model trained for a first domain to make accurate predictions in a second, known domain.

For purposes of illustration, consider an ML model trained to recognize a given object or class of object using data from a selected domain. That ML model may be unable to reliably recognize the same object or class of object in images of different domains. As a simplified example, consider the case where the ML model is trained to recognize cars from photorealistic images of cars. The ML model may reliably detect cars in such photorealistic image data but perform poorly when presented with image data specifying cars from different domains. The ML model, for example, may be unable to reliably detect cars within sketch images or cartoon images, which represent different domains than photorealistic images.

The embodiments described within this disclosure may be applied in any of a variety of real-world contexts relating to image processing to process data, e.g., images, from multiple different domains. Such data, e.g., from different domains, is also referred to as “out-of-distribution” or “OOD” data. For purposes of illustration and not limitation, the embodiments may be used in the field of medical image processing. In that context, different domains of image data may include each different medical site being considered a different domain in consequence of differences in the equipment used to generate the images. For example, differences in scanners, protocols, patient cohorts, and the like taken individually or in any combination may result in different domains of images to which the training embodiments and inference embodiments described herein may be used. Whereas with conventional ML models and ML training techniques, differences in medical sites, scanners, protocols, patient cohorts, and the like may result in different image domains that cause the ML model to fail to correctly classify images (and thereby fail to make an accurate diagnosis), the inventive arrangements described herein provide the technical effect of more accurately and/or more reliably classifying images from such different domains. Appreciably, medical images are used for purposes of illustration. The inventive arrangements are not intended to be limited to any particular application or context.

In some aspects, the techniques described herein relate to training a ML model such that the ML model, as trained, is able to classify images across different domains. The techniques include processing, using computer hardware, a first plurality of images belonging to a first domain through a first network. For example, images of the first domain are processed by the first network only. This provides the technical effect that the first network learns features of images of the same class and also features that may be particular to the first domain. The techniques include processing, using the computer hardware, a second plurality of images belonging to a second domain through a second network. For example, images of the second domain are processed by the second network only. This provides the technical effect that the second network learns features of images of the same class and also features that may be particular to the second domain.

The techniques include generating, using the computer hardware, a compound error metric (Lₜₒₜₐₗ) from a plurality of error metrics (e.g., Lₘₛₑ, L_{ce}, L_{SC}) derived from results generated from the processing of the first network and the processing of the second network. The use of a compound error metric provides the technical effect of addressing a plurality of different goals in the training process concurrently. For example, the compound error metric, as used during the training process, includes components (e.g., L_{intraSC} and L_{interSC}) that ensure that the training process accounts for differences between different classes of objects whether such objects are members of a same domain or are members of different domains. The compound error metric, as used during the training process, includes components (e.g., L_{interSC}, Lₘₛₑ) that ensure that the training process, for images of the same class and from different domains, learns or accounts for features particular to the class(es) while discounting features that are attributable to the domains.

The techniques include updating, using the computer hardware, weights of the first network based on the compound error metric. In one or more examples, the weights of the first network may be trained using a gradient descent technique based on the compound error metric. The technical effect of updating the first network with this technique is that the network updates more often and adapts faster to the images that are processed. The techniques also include updating, using the computer hardware, weights of the second network using a moving average technique that is dependent on the weights of the first network as updated. The second network is updated using a weight updating technique that is different from the weight updating technique of the first network. The technical effect of updating the second network with this technique is that the second network is updated more slowly based on a moving average of weights of the first network.

By using two networks that, as described hereinbelow, are architecturally similar or the same, but have different weights owing, at least in part to the update processes used, additional error metrics may be determined that are included in the compound error metric. The architecture disclosed herein provides technical effects similar to those of student-teacher networks or knowledge distillation. The target network is slowly updated and is able to learn from previously seen data, which helps the target network to remember such data (e.g., not to forget). The online network learns to approximate the predicted targets produced by the target network, which has the benefit of memory.

In some aspects, the first plurality of images and the second plurality of images are ordered according to class as processed by the first network and the second network. Ordering the images provided to the respective networks provides the technical effect that both networks are processing images of the same class albeit from different domains concurrently or simultaneously as the case may be. Thus, any error metrics that are calculated are able to distinguish between features attributable to the class of the images and features attributable to the domains of the image. These error metrics, as embodied in the compound error metric, influence the training and updating of weights in the respective networks. In one or more aspects, the error metrics as embodied in the compound error metric may directly influence weights of the first network and indirectly influence weights of the second network.

In some aspects, the first network includes an online encoder, an online projector, an online predictor, and a classifier. The second network includes a target encoder and a target projector. The first network, through inclusion of a classifier, facilitates the generation of an error metric (e.g., L_{ce}) relating to the operation of the classifier in predicting the classes or labels of the first plurality of images processed against the ground truth labels (e.g., classes) of respective ones of the first plurality of images.

In some aspects, the classifier is configured to receive embeddings generated by the online encoder. The technical effect of providing embeddings from the online encoder is that the embedding, as output from the online encoder, is configured to move the representation of the first plurality of images in the embeddings closer to those of the embeddings generated by the second network which processes the second plurality of images of the second domain. Thus, the classifier is learning to predict the class of received images from an embedding space in which images of same class are closer to one another than images of different classes regardless of domain membership.

In some aspects, the plurality of error metrics includes a selected error metric (e.g., L_{ce}) generated based on classification results from the classifier of the first network and ground truth labels of the first plurality of images. A technical effect of the selected error metric is that the performance of the classifier in predicting the labels of received images is generated with respect to a ground truth label. Thus, the compound error metric, as applied through training, updates the weights of the classifier to more accurately predict the label of received images even as images of different domains may be provided over time at least at inference time.

In some aspects, the plurality of error metrics include a supervised contrastive loss (e.g., L_{SC}). A technical effect of the supervised contrastive loss is that the error metric accounts for both similarities in images of the same class in the same domain and similarities between images of the same class in different domains. The supervised contrastive loss can include an intra-domain error (e.g., L_{intraSC}), e.g., a component, generated by comparing images in same mini-batches having same labels only for the first plurality of images. The technical effect of including the intra-domain error is the ability to specify or quantify a measure of error between embeddings of images in the same mini-batch, having same labels (e.g., being of the same class), and belonging to the same domain. The supervised contrastive loss can include an inter-domain error (e.g., L_{interSC}), e.g., another component, generated by comparing mini-batches of images of the first plurality of images with mini-batches of images of the second plurality of images, wherein the inter-domain error compares images with same labels. The technical effect of the inter-domain error is the ability to specify or quantify a measure of error between embeddings of images of the first domain and embeddings of images of the second domain, wherein the images have the same label (e.g., are of the same class). It should be appreciated that while comparisons of images are referenced, the comparisons and generation of the respective components of the supervised contrastive loss are performed using embeddings.

In some aspects, the plurality of error metrics includes a selected error metric (e.g., Lₘₛₑ) generated based on a prediction similarity between the first network and the second network. The Lₘₛₑ is used to measure similarity between features of the first network and features of the second network.

The predictor module is in the online network since it is updated using gradients and we are learning a classification task. We only use it for the online network since the division of domains to online and target comes from the field of meta-learning where we simulate a situation of an unseen domain in the target path and we don't want to learn the classification task on it.

The inventive arrangements provide additional technical effects in that a single or same ML model may be used across different domains. The ability to generalize an ML model across different domains means that the same ML model may be utilized to obtain reliable results for more than one domain rather than training and deploying a plurality of different ML models. Moreover, using a plurality of domain specific models requires that the domain of images be known a priori when this is not always knowable. By comparison, an ML model trained for domain generalization as described herein may process images of different domains without knowing a priori the domain(s) to which the images belong and may also operate on domains unseen during training.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

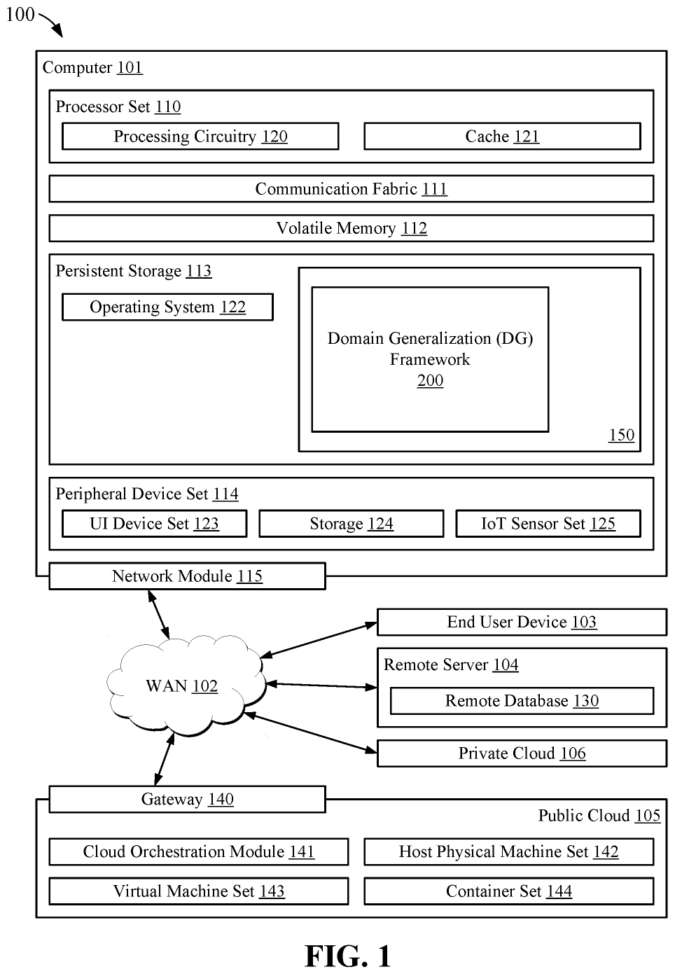

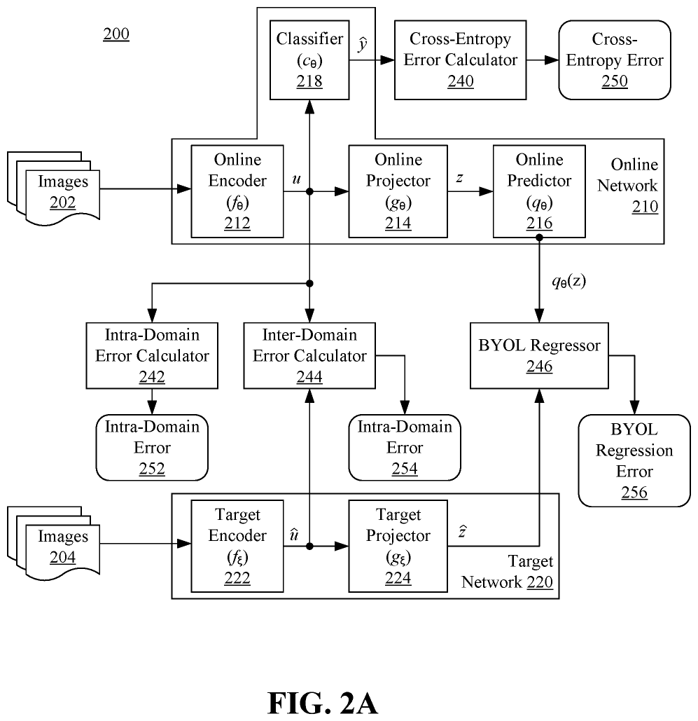

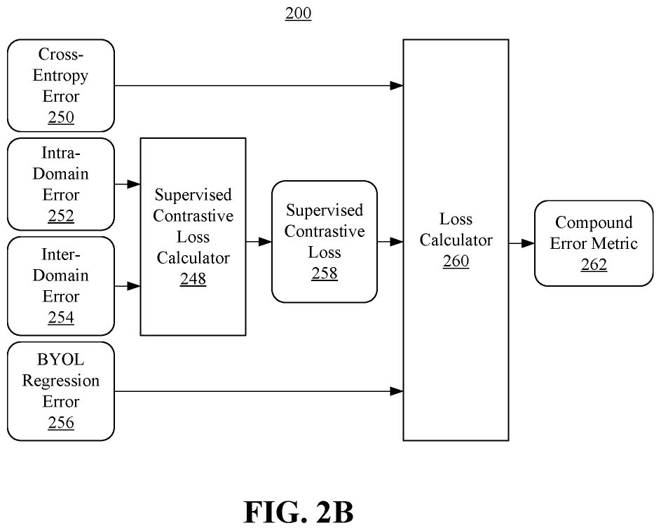

FIG. 1 illustrates a computing environment 100 that is suitable for training an ML model and executing an ML model (e.g., at runtime or inference time). Referring to FIG. 1, computing environment 100 contains an example of an environment for the execution of at least some of the computer code in block 150 involved in performing the inventive methods, such as domain generalization (DG) framework 200 implemented as executable program code or instructions. DG framework 200 is capable of training an ML model to reliably recognize or classify objects at runtime that belong to one or more different domains and potentially domains that were not seen during training. Within this disclosure, the term “runtime” or “inference time,” in the context of an ML model, means the time that the ML model is run or executed by computer hardware post training to perform inference. Within this disclosure, the term “domain” means a data set having a data distribution that differs from the data distribution of another, different data set. Thus, two domains including objects belonging to one or more same classes will have different data distributions. The resulting ML model, as trained using DG framework 200, is capable of reliably classifying received input across the different domains. The inventive arrangements, as embodied in DG framework 200, are capable of performing executable operations such as those described herein in connection with FIGS. 2, 3, 4, and 5.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIGS. 2A and 2B, taken collectively and collectively referred to as FIG. 2, illustrate DG framework 200 in accordance with one or more embodiments of the disclosed technology. In one or more embodiments, DG framework is capable of operating as a domain invariant feature extractor. DG framework 200 is capable of training an ML model to capture semantic information while remaining insensitive to domain specific features. In one or more embodiments, DG framework 200 incorporates one or more features of a self-supervised learning framework as generally described in Grill et al., “Bootstrap Your Own Latent-A New Approach to Self-Supervised Learning,” Advances in Neural Information Processing Systems, v. 33, pp. 21271-21284, Curran Associates, Inc. (2020) (hereafter BYOL).

In the example of FIG. 2, DG framework 200 includes an online network 210 and a target network 220. In one or more embodiments, online network 210 and target network 220 may be implemented as convolutional neural networks. Online network 210 is also referred to herein as the “first network.” Target network 220 is also referred to herein as the “second network.” In the example, online network 210 includes an online encoder 212 (f_{θ}), an online projector 214 (g_{θ}), an online predictor 216 (q_{θ}), and a classifier 218 (c_{θ}). Target network 220 includes a target encoder 222 (f_{ξ}) and a classifier 218 (g_{ξ}). For purposes of illustration, within this disclosure, parameters of online network 210 are referred to as e while the parameters of target network 220 are referred to as ξ.

In one or more embodiments, online predictor 216 is included in online network 210 as online network 210, inclusive of online predictor 216, is updated using gradients and a classification task is being learned. Online predictor 216 is included in online network 210 as DG framework 200, for training purposes, simulates the situation of an unseen domain in target network 220 where a classification task is not being learned.

In accordance with the inventive arrangements, and unlike the self-supervised learning framework described in BYOL, online network 210 receives images 202 of one or more classes that belong to a first domain also referred to herein as Dᵢ. Target network 220 receives images 204 of the same one or more classes. Whereas images 202 belong to a first domain Dᵢ, images 204 belong to a second domain Dⱼ. Images 202 may be provided to online network 210 and images 204 provided to target network 220 in mini-batch sizes of N images. Each image may be provided to online network 210 and to target network 220 as an image-label pair denoted as (xₖ, yₖ), where k=1, . . . , N. In the example, domain Dᵢ is part of a meta-train set that is used in online network 210. Domain Dⱼ is part of a meta-test set used in target network 220. Within this disclosure, though the term “label” refers to a data item that specifies a class, the terms “class” and “label” may be used interchangeably from time-to-time.

With the exception of online predictor 216 and classifier 218, online network 210 and target network 220 are substantially similar to one another. Online encoder 212 and online projector 214 may be implemented, from an architectural perspective, to be the same as target encoder 222 and target projector 224, respectively. That is, though online encoder 212 and target encoder 222 may be architecturally the same, each encoder will have different weights that are updated during training using different weight updating techniques. Similarly, though online projector 214 and target projector 224 may be architecturally the same, each projector will have different weights that are updated during training using different weight updating techniques. Thus, the weights of online network 210 are updated differently, e.g., using a different weight updating technique, than the weights of target network 220.

DG framework 200 includes additional blocks such as a classifier 218, a plurality of error calculators, and a loss calculator 260. The error calculators include a cross-entropy calculator 240, an intra-domain error calculator 242, an inter-domain error calculator 244, and a BYOL regressor 246. Cross-entropy calculator 240 is capable of generating an error metric such as a cross-entropy error 250. Intra-domain error calculator 242 is capable of generating an error metric such as an intra-domain error 252. Inter-domain error calculator 244 is capable of generating an error metric such as an inter-domain error 254. BYOL regressor 246 is capable of generating an error metric such as a BYOL regression error 256.

Supervised contrastive loss calculator 248 receives intra-domain error 252 and inter-domain error 254. Based on intra-domain error 252 and inter-domain error 254, supervised contrastive loss calculator 248 generates supervised contrastive loss 258. As illustrated, loss calculator 260 is capable of receiving the respective metrics. For example, loss calculator 260 receives cross-entropy error 250, supervised contrastive loss 258, and BYOL regression error 256. Based on the received metrics, loss calculator 260 generates a compound error metric 262. Online network 210 is trained using, at least in part, based on compound error metric 262.

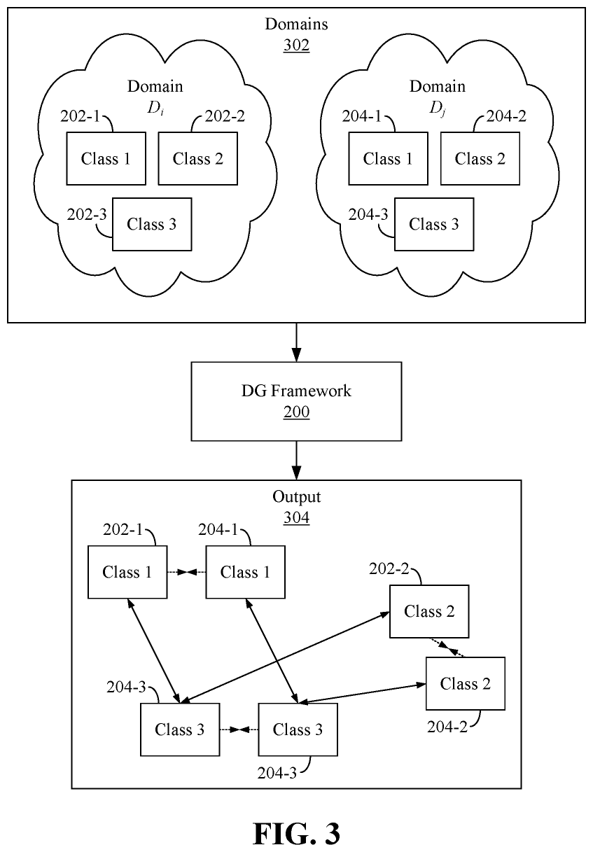

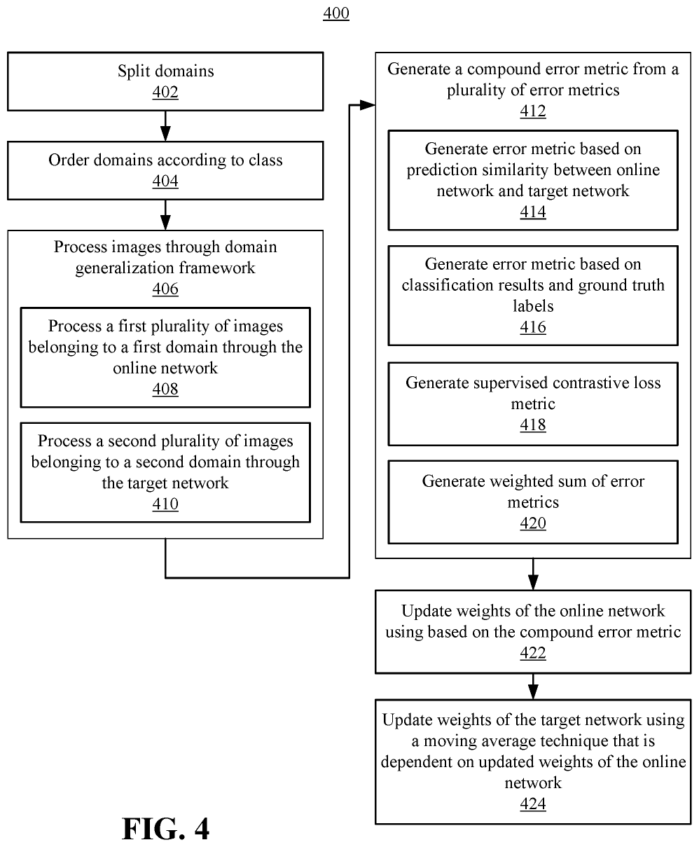

In the example, online network 210 generates, e.g., outputs a representation vector. Similarly, target network 220 generates, e.g., outputs, a representation vector. The training process is operative to bring the two representation vectors, corresponding to two different domains, close together. For example, BYOL regressor 246 is capable of comparing these representation vectors and outputting the error metric BYOL regression error 256. Further aspects of DG framework 200 are described in greater detail below in connection with FIGS. 3 and 4.

FIG. 3 illustrates certain operative features of DG framework 200 of FIGS. 1 and 2. In the example of FIG. 3, DG framework 200 is trained using a plurality of domains 302. In the example, domains Dᵢ and Dⱼ are illustrated with domain Dᵢ including a plurality of images 202-1, 202-2, and 202-3 and domain Dⱼ including a plurality of images 204-1, 204-2, and 204-3. For purposes of illustration, domain Dᵢ includes photorealistic images such as images taken with a camera. Domain Dⱼ includes images that are cartoons. Each domain Dᵢ and Dⱼ includes images of the same set of classes. For example, image 202-1 and image 204-1 correspond to class 1, image 202-2 and image 204-2 correspond to class 2, and image 202-3 and image 204-3 correspond to class 3. For purposes of discussion in this example, class 1 is formed of images that include a guitar. Class 2 is formed of images that include a horse. Class 3 is formed of images that include a house.

In providing a mini-batch of N images 202 to online network 210 and a mini-batch of N images 204 to target network 220, images 202 and 204 are aligned according to class (e.g., label). For example, online network 210 and target network 220 each receives a mini-batch of images where the images of both mini-batches belong to the same class. Online network 210 and target network 220, for example, may process mini-batches of images until the images of that class are complete, followed by one or more mini-batches of images of a next class, etc. Further, during training, online network 210 and target network 220 receive images of the same class but from different domains. For example, online network 210 receives an image 202, from domain Dᵢ, with a label of class 1 concurrently or simultaneously with target network 220 receiving an image 204 from domain Dⱼ, also with a label of class 1.

Output 304 illustrates that DG framework 200 is trained to bring together images having same classifications whether the images are within the same domain or exist in different domains. DG framework 200 is further trained to drive apart images of different classifications whether such images are in the same domain or in different domains. In the example, solid arrows with arrowheads facing outward represent repulsive forces pushing images apart in an embedding space (e.g., the embedding space(s) as output from the encoders and/or as output from the projectors) while dashed arrow with the arrowheads pointing in toward one another represent attractive forces that pull images closer to one another in the embedding space (e.g., as measured using a distance metric). As illustrated, image pairs (202-1, 204-1) both labeled as “class 1,” (202-2, 204-2) both being labeled “class 2,” and (202-3, 204-3) both being labeled “class 3” are joined by an attractive force that brings the respective pairs of images closer to one another in the embedding space. Conversely, images pairs (202-1, 204-3), (204-1, 204-3), (204-3, 202-2), and (204-3, 204-2) are coupled by repulsive forces as the images in each pair are labeled with different classes and are pushed apart in the embedding space.

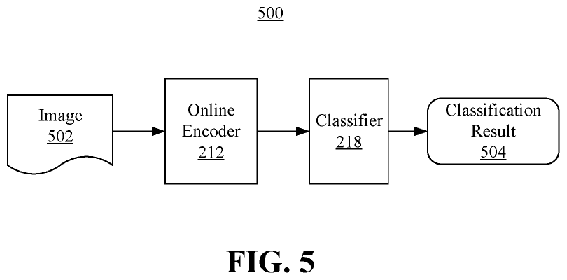

Example 1 below is pseudo code illustrating operations performed by DG framework 200 of FIGS. 1 and 2 in training the ML model. For purposes of illustration, the trained ML model is formed of online encoder 212 and classifier 218, which is illustrated as the inference system in FIG. 5.

### Example 1

| | | |
|---|---|---|
| 1. | Input | : Domains S, Model θ, U # meta-test |
| 2. | Output | : Lₜₒₜₐₗ |

| | |
|---|---|
| 3. | for itr in iterations do |
| 4. | Split S domains to {Dᵢ\|i = S − U}, {Dⱼ \|j = 1...U} |
| 5. | xᵢ, yᵢ, xⱼ, yⱼ ← OrderDomains(xᵢ, yᵢ, xⱼ, yⱼ) |
| 6. | pᵢ, zⱼ, yᵢ, uᵢ, uⱼ ← BYOLDG(xᵢ, xⱼ) |
| 7. | L_{CE} ← CrossEntropy(xi, yi) |
| 8. | L_{MSE} ← MSE(pᵢ, zⱼ) |
| 9. | L_{SC} ← intraSC(uᵢ, uᵢ) + interSC(uᵢ, uⱼ) |
| 10. | Optimize Update θ ← Adam(αL_{CE} + βL_{MSE} + γL_{SC}) |
| 11. | end |

In one or more embodiments, in reference to Example 1, inputs to online network 210 and target network 220 may be switched to simulate evaluation of the meta-test as an “unseen” domain so that only xᵢ undergoes classification. The model is trained on all pairs of S, U in aggregate.

FIG. 4 is a method 400 illustrating certain operative features of DG framework 200 of FIGS. 1, 2, and 3 in accordance with one or more embodiments of the disclosed technology. Method 400 illustrates example operations performed by DG framework 200 in training an ML model to reliably or accurately classify objects in images across a plurality of domains (e.g., train a domain generalized ML model). For example, the operations illustrated in FIG. 4 correspond to the operations of the loop body of Example 1 corresponding to lines 4-10.

In the context of FIG. 4, there are a set of M training domains called “source domains” denoted as Sₜᵣₐᵢₙ={Dₘ|m=1, . . . , M}, where Dₘ={xᵢ, yᵢ}ᵢ₌₁^{N}^{ₘ}˜P_{XY}^{(m)} is m-th domain with Nₘ data samples xᵢ∈X⊂ [symbol] , their corresponding labels yᵢ∈Y⊂ [symbol] and P_{XY}=P(X, Y) is the joint distribution of input samples and labels, where X and Y denote the corresponding random variables. The joint distributions of the domains are pairwise different: P_{XY}^{(m)}≠P_{XY}^{(m′)} for all m≠m′. In general, the ML model is trained to learn a function ƒ: X→Y from training domains that minimizes prediction error on a test domain Sₜₑₛₜ that is different from all of the source domains.

In some embodiments, the ML model may be considered to be trained where or when a loss function (e.g., the compound error metric 262) is minimized and/or upon the accuracy of the trained ML model being greater than or equal to a threshold accuracy score (e.g., 85% or greater, 90% or greater, 95% or greater, etc.) obtained using test data. In some embodiments, some or all of the weights and biases learned by the ML model may be retained for inference operations for downstream tasks.

In block 402, the domains are split for processing. Block 402 corresponds to line 4 of Example 1 above. In the example of FIG. 4, a meta-learning domain selection scheme is used for each mini-batch. The splitting operation of block 402 may be performed as follows: given S training domains {Dₖ}_{k=1, . . . , s}, the domains S are randomly split into S-U meta-train domains Ŝ with input pairs {xᵢ, yᵢ}ᵢ₌₁ⁿ and U meta-test domains with {xⱼ, yⱼ}ⱼ₌₁^{m}. The meta-train set Ŝ follows, e.g., is provided as input to, online network 210 while the meta-test set U follows, e.g., is provided as input to, target network 220. The number of meta test domains U is a hyper-parameter.

In block 404, the domains are ordered according to class. Block 404 corresponds to line 5 of Example 1 above. For example, the images of each domain are ordered according to class or label. The ordering ensures that as pairs of images are provided to DG framework 200, a first image of each pair is provided to online network 210 and the second image of each pair is provided to target network 220. For each pair of images provided to DG framework 200, both images are of the same class and, as such, have the same label, but belong to different domains.

In block 406, DG framework 200 processes images. Image pairs are processed through online network 210 and through target network 220. Block 406 corresponds to line 6 of Example 1 above. Images are provided to DG framework 200 in pairs as described where online network 210 receives the first image of each pair while target network 220 receives the second image of each pair.

For example, in block 408, a first plurality of images (e.g., a mini-batch of images N), is processed through online network 210. As noted, online network 210 is also referred to as the “first network.” The first plurality of images belong to a first domain. Each image of the first plurality of images is processed through online encoder 212 to obtain an embedding u, which is provided to classifier 218 and to online projector 214. Classifier 218, based on the received embedding u, generates a classification result ŷ for each image of the first plurality of images. Online projector 214, based on the embedding u, generates an output z. Online predictor 216, based on the output z from online projector 214, outputs a prediction denoted as q_{θ}(z).

In general, online projector 214 projects embeddings u into a different size corresponding to z. Typically, online projector 214 has the effect of reducing the number of features significantly. In addition to the reduction in feature size, which makes the embeddings more manageable and reduces the computational overhead of DG framework 200, the embeddings u are further projected into embedding space z that is closer to the embedding space \hat{z} corresponding to target network 220. Target projector 224 operates substantially similar to online projector 214 albeit having different weights as previously noted. Accordingly, target projector 224 projects embeddings û into a different size corresponding to \hat{z}. Typically, target projector 224 has the effect of reducing the number of features significantly. In addition to the reduction in feature size, which makes the embeddings more manageable and reduces the computational overhead of DG framework 200, the embeddings û are further projected into the embedding space \hat{z} that is closer to the space z corresponding to online network 210.

In block 410, a second plurality of images (e.g., a mini-batch of images N) is processed by target network 220. As noted, target network 220 is also referred to as the “second network.” The second plurality of images belongs to a second domain (e.g., a domain different from the domain of the first plurality of images). Each image of the second plurality of images is processed through target encoder 222 to obtain an embedding û, which is provided to target projector 224. Target projector 224, based on the embedding û, generates an output 2.

In one or more embodiments, the class of the images provided to DG framework 200 in pairs may be held constant over each mini-batch of N images. Once a mini-batch is processed, the class of image pairs for the next mini-batch may be changed to a different class. In another aspect, the class of image pairs for the next mini-batch and/or further mini-batches may continue or remain unchanged until all images of that class for the two domains have been exhausted, at which point image pairs belonging to different domains for a different class may be fed into DG framework 200.

In block 412, DG framework 200 generates compound error metric 262 from a plurality of error metrics. The error metrics used to generate compound error metric 262 are derived from results generated from the processing of the first network and the processing of the second network. For example, in block 414, DG framework 200 generates an error metric based on a predicted similarity between online network 210 and target network 220. Block 414 corresponds to line 8 of Example 1 above. More particularly, in block 414, BYOL regressor 246 generates the BYOL regression error 256. The BYOL regression error 256 is shown below in Expression 1 as Lₘₛₑ. As discussed, q_{θ} represents online predictor 216. The terms z and \hat{z} are the outputs of the of online projector 214 and target projector 224, respectively.

$${L}_{mse} = 2 - 2 \cdot \frac{〈 {q}_{θ} ( z ) , \hat{z} 〉}{{‖ {q}_{θ} ( z ) ‖}_{2} \cdot {‖ \hat{z} ‖}_{2} .} \qquad ( 1 )$$

In Expression 1, BYOL regressor 246 calculates the mean squares error as a loss function. In the case of BYOL, the error pushes the ML model to learn the augmentation that was applied to the image and demand the prediction similarity between the images (image and augmented image) independent of the augmentation applied. In the case of DG framework 200, the relationship between the two domains corresponding to online network 210 and target network 220 is viewed or considered a similarity problem. Thus, BYOL regression error 256 in the context of DG framework 200 pushes the ML model to learn the transformation between the two domains being processed for the mini-batch of images.

In block 416, DG framework 200 generates an error metric based on a classification result and ground truth label referred to herein as cross-entropy error 250. Block 416 corresponds to line 7 of Example 1 above. For example, cross-entropy error calculator 240 calculates a cross entropy error 250, which is also denoted herein as L_{CE}. The cross-entropy error 250 is calculated based on the classification results from classifier 218 and ground truth labels (e.g., yᵢ) of the first plurality of images and is shown below in Expression 2.

Referring to FIG. 2, the augmentations applied to images are implemented or realized as the inherent difference between domains. DG framework 200 solves a supervised task and uses the labels to match between domain images to encourage domain similarity. The set of images and labels is defined as (xᵢ, yᵢ) for online network 210 and (xⱼ, yⱼ) for target network 220. As discussed, each mini-batch is ordered according to the image labels such that the target images (e.g., images 204) and the online images (e.g., image 202) are paired with the same class. The embeddings u obtained from online encoder 212 are fed into classifier 218. Cross-entropy calculator 240 is capable of generating cross-entropy error 250 using Expression 2. Within Expression 2 below, ŷᵢ is the predicted label and yᵢ is the ground truth label.

$${L}_{ce} = - \frac{1}{N} {\sum }_{i = 0}^{N} {y}_{i} log ( {\hat{y}}_{i} ) \qquad ( 2 )$$

In block 418, DG framework 200 generates an error metric referred to as supervised contrastive loss 258. Block 418 corresponds to line 9 of Example 1 above. Supervised contrastive loss 258 is also denoted herein as L_{SC}. As illustrated, supervised contrastive loss calculator 248 generates supervised contrastive loss 258 based on two different components. The first component is intra-domain error 252, which is also denoted as L_{intraSC} within this disclosure. In general, intra-domain error 252 is generated by comparing images in same mini-batches having same labels only for the first plurality of images (e.g., for online network 210). The second component is inter-domain error 254, which is also denoted as L_{interSC} within this disclosure. In general, inter-domain error 254 is generated by comparing mini-batches of images of the first plurality of images with mini-batches of images of the second plurality of images. Still, the comparisons performed for inter-domain error 254 compare images with same labels.

Intra-domain error 252 and inter-domain error 254 ensure that inter-domain representation differences are minimized while intra-domain variations are also considered. Thus, supervised contrastive loss 258 ensures that all sample representations from the same class in a mini-batch, whether such sample representations are from the same domain or different domains, are brought closer together in the embedding space.

Referring to intra-domain error 252 as generated by intra-domain error calculator 242, a mini-batch of N samples is defined as {xₖ, yₖ}_{k=1, . . . , N} with representation vectors {uₖ}ₖ₌₀^{N} as the output of online encoder 212. Intra-domain error 252 is computed over a mini-batch and compares each example in the mini-batch to the other examples in the mini-batch that share the same label. For each k, P(k)={uᵢ|yᵢ=yₖ, l≠k} is defined which includes all examples sharing the same label as uₖ. Intra-domain error 252, e.g., L_{intraSC}, is generated by intra-domain error calculator 242 using Expression 3 below. Within Expression 3, τ is a temperature hyperparameter.

$${L}_{intraSC} = {\sum }_{k ∈ N} \frac{- 1}{\vert P ( k ) \vert} {\sum }_{{u}_{1} ∈ P ( k )} log \frac{exp ( {u}_{k} \cdot \frac{{u}_{l}}{τ} )}{{\sum }_{\begin{matrix}n ∈ N \\ n \neq k\end{matrix}} exp ( {u}_{k} \cdot \frac{{u}_{n}}{τ} )} \qquad ( 3 )$$

Inter-domain error 254, as generated by inter-domain error calculator 244, is similar to intra-domain error 252. Instead of comparing a mini-batch to itself, inter-domain error calculator 244 compares examples of a mini-batch of one domain Dᵢ to the examples of another domain Dᵢ with representations {uₖ}ₖ₌₀^{N} and {ûₖ}ₖ₌₀^{N}, respectively. In the case of inter-domain error 252, \hat{P}(k)={ûᵢ|ŷᵢ=yₖ} is defined. Inter-domain error 254, e.g., L_{interSC}, is generated by inter-domain error calculator 244 using Expression 4 below.

$${L}_{interSC} = {\sum }_{k ∈ N} \frac{- 1}{\vert P ( k ) \vert} {\sum }_{{\hat{u}}_{1} ∈ \hat{P} ( k )} log \frac{exp ( {u}_{k} \cdot \frac{{\hat{u}}_{l}}{τ} )}{{\sum }_{n ∈ N} exp ( {u}_{k} \cdot \frac{{\hat{u}}_{n}}{τ} )} \qquad ( 4 )$$

As part of block 418, supervised contrastive loss calculator 248 generates supervised contrastive loss 258 by summing intra-domain error 252 and inter-domain error 254 in accordance with Expression 5 below.

$${L}_{SC} = {L}_{intraSC} + {L}_{interSC} \qquad ( 5 )$$

In block 420, DG framework 200 and, more particularly, loss calculator 260, generates a weighted sum of the error metrics as compound error metric 262 in accordance with Expression 6 below where α, β, and γ are weights for the respective error metrics. Compound error metric 262 is also denoted herein as Lₜₒₜₐₗ.

$${L}_{total} = α {L}_{CE} + β {L}_{MSE} + γ {L}_{SC} \qquad ( 6 )$$

In block 422, the weights of online network 210 are updated. In one or more embodiments, the weights of online network 210 are updated using a gradient descent technique based on compound error metric 262.

In block 424, the weights of target network 220 are updated. In one or more embodiments, the weights of target network 220 are updated using a moving average technique. The moving average technique is dependent on, e.g., is a moving average of, the weights of online network 210. In one or more embodiments, the moving average technique is an exponential moving average technique. The updating of weights of target network 220 is an example of a momentum updating scheme.

In one or more embodiments, during the training process, online network 210 is updated at every step using the optimizer rule in reference to block 422. In reference to block 424, target network 220 may be updated using Expression 7 below. In Expression 7, τ is a weight decay parameter in the range of [0, 1] and s is the update step.

$${ξ}_{s} = {τξ}_{s - 1} + ( 1 - τ ) θ \qquad ( 7 )$$

Thus, in reference to blocks 422 and 424, in each mini-batch, DG framework 200 computes the compound error metric 262. This loss is backpropagated to update the weights of online network 210 and, more particularly, online encoder 212, online projector 214, online predictor 216, and classifier 218. The gradient of the respective components is calculated and the components (e.g., weights thereof) updated. The weights of target network 220 and, more particularly, target encoder 222 and target projector 224 follow the weights of online network 210 as a moving average of those weights. Blocks 420, 422, and 424 generally correspond to line 10 of Example 1 above.

As discussed, method 400 illustrates operations performed as part of the body of the loop illustrated in Example 1. As noted, in one or more embodiments, inputs to online network 210 and target network 220 may be switched to simulate evaluation of the meta-test as an “unseen” domain so that only xᵢ undergoes classification. The model is trained on all pairs of Ŝ, U in aggregate. The training process described herein may continue or iterate for a predetermined number of iterations or until the ML model converges to a particular desired level of accuracy.

At runtime, e.g., inference time, the only components retained for operation are online encoder 212 and classifier 218. The other components illustrated in FIG. 2 are discarded.

FIG. 5 illustrates a DG framework 500 trained to perform inference in accordance with one or more embodiments of the disclosed technology. As shown, DG framework 500 includes online encoder 212 and classifier 218 as trained per the embodiments described herein. DG framework 500 is capable of accurately classifying received images, e.g., image 502, from one or more different domains. DG framework 500 is capable of outputting a classification result 504 such as a predicted label specifying a particular class for image 502.

The inventive arrangements described herein provide methods, systems, and computer-program products that implement domain generalization by using the inherent difference between domains as a transformation to be learned by bringing together similar object representations from different domains. In accordance with the inventive arrangements, two images are given as input to the DG framework instead of a single image with two augmentations. A mean squares error may be used as a loss function where to learn the augmentation that was applied to the image and demand the prediction similarity between the images independent of the transformation. In accordance with the inventive arrangements, the inherent difference between domains is considered instead of the augmentations applied in the self-supervised case. The DG framework learns to solve a supervised task with Cross-Entropy loss and using the labels to match between domain images in order to encourage domain similarity. A supervised contrastive loss is used where sample representations from the same class in a mini-batch and/or batch are brought closer together. Meta-learning may be used to train the DG framework, at least in part, by iteratively changing domain roles between meta-train and meta-test. As noted, domains are used as input as opposed to a single image, together with different loss combinations to give/provide improved domain invariance.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

The terms “processor set” and “processor circuitry” refer to at least one hardware circuit configured to carry out instructions. The instructions may be contained in program code. The hardware circuit may be an integrated circuit. Examples include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

The term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training a machine learning model, the method comprising:
processing, using computer hardware, a first plurality of images belonging to a first domain through a first network;
processing, using the computer hardware, a second plurality of images belonging to a second domain through a second network;
generating, using the computer hardware, a compound error metric from a plurality of error metrics derived from results generated from the processing of the first network and the processing of the second network;
updating, using the computer hardware, weights of the first network based on the compound error metric; and
updating, using the computer hardware, weights of the second network using a moving average technique that is dependent on the weights of the first network as updated.

2. The method of claim 1, wherein the first plurality of images and the second plurality of images are ordered according to class as processed by the first network and the second network.

3. The method of claim 1, wherein:
the first network includes an online encoder, an online projector, an online predictor, and a classifier; and
the second network includes a target encoder and a target projector.

4. The method of claim 3, wherein the classifier is configured to receive embeddings generated by the online encoder.

5. The method of claim 1, wherein the plurality of error metrics includes a selected error metric generated based on classification results from a classifier of the first network and ground truth labels of the first plurality of images.

6. The method of claim 1, wherein the plurality of error metrics include a supervised contrastive loss comprising:
an intra-domain error generated by comparing images in same mini-batches having same labels only for the first plurality of images; and
an inter-domain error generated by comparing mini-batches of images of the first plurality of images with mini-batches of images of the second plurality of images, wherein the inter-domain error compares images with same labels.

7. The method of claim 1, wherein the plurality of error metrics includes a selected error metric generated based on a prediction similarity between the first network and the second network.

8. A system for training a machine learning model, comprising:
one or more processors configured to execute operations including:
processing a first plurality of images belonging to a first domain through a first network;
processing a second plurality of images belonging to a second domain through a second network;
generating a compound error metric from a plurality of error metrics derived from results generated from the processing of the first network and the processing of the second network;
updating weights of the first network based on the compound error metric; and
updating weights of the second network using a moving average technique that is dependent on the weights of the first network as updated.

9. The system of claim 8, wherein the first plurality of images and the second plurality of images are ordered according to class as processed by the first network and the second network.

10. The system of claim 8, wherein:
the first network includes an online encoder, an online projector, an online predictor, and a classifier; and
the second network includes a target encoder and a target projector.

11. The system of claim 10, wherein the classifier is configured to receive embeddings generated by the online encoder.

12. The system of claim 8, wherein the plurality of error metrics includes a selected error metric generated based on classification results from a classifier of the first network and ground truth labels of the first plurality of images.

13. The system of claim 8, wherein the plurality of error metrics include a supervised contrastive loss comprising:
an intra-domain error generated by comparing images in same mini-batches having same labels only for the first plurality of images; and
an inter-domain error generated by comparing mini-batches of images of the first plurality of images with mini-batches of images of the second plurality of images, wherein the inter-domain error compares images with same labels.

14. The system of claim 8, wherein the plurality of error metrics includes a selected error metric generated based on a prediction similarity between the first network and the second network.

15. A computer program product comprising one or more computer readable storage mediums having program instructions embodied therewith, wherein the program instructions are executable by one or more processors to cause the one or more processors to execute operations comprising:
processing a first plurality of images belonging to a first domain through a first network;
processing a second plurality of images belonging to a second domain through a second network;
generating a compound error metric from a plurality of error metrics derived from results generated from the processing of the first network and the processing of the second network;
updating weights of the first network based on the compound error metric; and
updating weights of the second network using a moving average technique that is dependent on the weights of the first network as updated.

16. The computer program product of claim 15, wherein the first plurality of images and the second plurality of images are ordered according to class as processed by the first network and the second network.

17. The computer program product of claim 15, wherein:
the first network includes an online encoder, an online projector, an online predictor, and a classifier; and
the second network includes a target encoder and a target projector.

18. The computer program product of claim 15, wherein the plurality of error metrics includes a selected error metric generated based on classification results from a classifier of the first network and ground truth labels of the first plurality of images.

19. The computer program product of claim 15, wherein the plurality of error metrics include a supervised contrastive loss comprising:
an intra-domain error generated by comparing images in same mini-batches having same labels only for the first plurality of images; and
an inter-domain error generated by comparing mini-batches of images of the first plurality of images with mini-batches of images of the second plurality of images, wherein the inter-domain error compares images with same labels.

20. The computer program product of claim 15, wherein the plurality of error metrics includes a selected error metric generated based on a prediction similarity between the first network and the second network.
